(19) United States
(12) Patent Application Publication
(10) Pub. No.: US 2007/0265382 A1
(43) Pub. Date: Nov. 15, 2007

(54) Polybutylene Terephthalate Pellet, Compound Product and Molded Product Using the Same, and Processes for Producing the Compound Product and Molded Product

(75) Inventor: Masanori Yamamoto, Yokkaichi-shi (JP)

Correspondence Address: NIXON & VANDERHYE, PC, 901 NORTH GLEBE ROAD, 11TH FLOOR, ARLINGTON, VA, 22203, US

(73) Assignee: MITSUBISHI CHEMICAL CORPORATION, MINATO-KU TOKYO, JAPAN (JP)

(21) Appl. No.: 10/587,520

(22) PCT Filed: Mar. 4, 2005
(86) PCT No.: PCT/JP05/03765

§ 371 Date: Apr. 30, 2007

(30) Foreign Application Priority Data
Mar. 9, 2004 (JP) 2004-066271

(51) Int. Cl. C08K 3/08; B29B 7/00; B29B 9/12; C08G 63/85; C08J 3/12

(52) U.S. Cl. 524/440; 264/328.1

(57) ABSTRACT

An object of the present invention is to provide a polybutylene terephthalate pellet capable of producing a molded product which is excellent in color tone, hydrolysis resistance, transparency and molding stability, and has a less content of impurities. A polybutylene terephthalate pellet comprises polybutylene terephthalate containing titanium in an amount of not more than 90 ppm by weight, as calculated as titanium atom, and having an end methoxycarbonyl group concentration of not more than 0.5 μeq/g, wherein said pellet has an average intrinsic viscosity of 0.90 to 2.00 dL/g and a difference in intrinsic viscosity between a central portion and a surface layer portion of the pellet is not more than 0.10 dL/g. As preferred embodiments, there is exemplified a polybutylene terephthalate pellet having an end carboxyl concentration of 10 to 25 μeq/g, an end vinyl concentration of 0.1 to 10 μeq/g, and an solution haze of not more than 5%, when measured as a turbidity value of a solution prepared by dissolving 2.7 g of polybutylene terephthalate in 20 mL of a mixed solution containing phenol and tetrachloroethane at a weight ratio of 3:2.

### TECHNICAL FIELD

The present invention relates to a polybutylene terephthalate pellet, a compound product and a molded product produced by using the polybutylene terephthalate pellet, and processes for producing the compound product and molded product. More particularly, the present invention relates to a polybutylene terephthalate pellet which is excellent in color tone, hydrolysis resistance and transparency, and exhibits a less content of impurities and an improved productivity, a compound product and a molded product produced by using such a polybutylene terephthalate pellet, and processes for producing the compound product and molded product. Meanwhile, hereinafter, polybutylene terephthalate is occasionally referred to merely as “PBT”.

### BACKGROUND ARTS

Among thermoplastic polyester resins, PBT is known as a typical engineering plastic material. PBT has been widely used for producing injection molded products such as automobile parts, electric and electronic parts, parts of precision equipments, or the like because of excellent moldability, mechanical properties, heat resistance, chemical resistance, aroma retention property (flavor barrier property), and other physical and chemical properties thereof. In recent years, PBT has also extensively been applied to fields of films, sheets, filaments, etc., owing its excellent properties. In these application fields, since the above products are generally produced by an extrusion-molding method, it is demanded to provide PBT having a higher molecular weight than that used for injection-molded products.

Usually, PBT is produced by subjecting terephthalic acid or an ester-forming derivative thereof and 1,4-butanediol to melt-polycondensation through esterification reaction or transesterification reaction therebetween in the presence of a catalyst, and then conducting a solid-phase polymerization, if required. However, PBT has such a problem that when exposed under a high temperature condition for a long period of time, PBT suffers from accelerated deterioration, resulting in poor color tone as well as the increase of an end carboxyl group concentration therein. Further, since PBT having a higher molecular weight undergoes a more severe heat history upon production thereof, PBT having a higher intrinsic viscosity tends to suffer from the above problems more remarkably when subjected to the melt-polymerization.

To solve the above problems, there has been widely adopted the method of producing PBT by conducting the melt-polymerization at a relatively low temperature for a short period of time, and then conducting the solid-phase polymerization at a temperature not more than a melting point thereof. Although the solid-phase polymerization method is excellent from the standpoints of improving a color tone of PBT and deceasing an end carboxyl group concentration therein, this method has various problems such as a prolonged polymerization time, a large energy loss and necessity of very large scale facilities. In addition, since cylindrical or spherical pellets are usually used in the solid-phase polymerization, a surface layer portion of the respective pellets where low-molecular weight components produced by the polymerization are more likely to be volatilized, tends to become a higher molecular weight, whereas a central portion thereof may fail to be increased in molecular weight thereof, resulting in occurrence of undesirable viscosity difference within the pellets. Such a viscosity difference of the pellets tends to cause not only increase in load applied to motors for driving screws of an extruder or a molding apparatus owing to unevenness of the molten pellets within the extruder or a molding apparatus, but also fluctuation thereof as well as deterioration in properties of products, resulting in problems concerning productivity.

Further, in the case where the pellets have a large viscosity difference therewithin, since the high molecular weight portions and low molecular weight portions thereof are not intimately mixed with each other, there arises such a problem that impurities such as fish eyes tend to be produced. In particular, in the above new applications of PBT such as films, sheets and filaments, this problem usually becomes more remarkable by the use of screws having a low kneading effect upon the molding, a less content of fillers or additives other than resins, etc., as compared to the conventional compound product applications in which PBT has been frequently used, or the like.

The impurities produced in PBT tend to cause large problems such as considerably deteriorated commercial value in the case of films or sheets, and rapture or breakage therearound in the case of filaments. Also, in these applications, it has been demanded to provide PBT having a high molecular weight as described above, and it has been required that the solid-phase polymerization reaction proceeds more fully. As a result, the pellets tend to be further increased in viscosity difference between the surface layer portion and central portion thereof, resulting in closed-up problems concerning the fish eyes.

To solve the above problems, there have been proposed such films in which the amount of fish eyes produced therein is reduced to not more than a specific amount by removing substances causing the fish eyes through a filter disposed in a polymerization process, without conducting the solid-phase polymerization (for example, patent literature 1).

However, in the conventional methods, since the amount of a titanium catalyst used therein is large, thereby deactivating and then precipitating a part of the titanium catalyst, there arises such a problem that the life of the filter used becomes considerably short. Further, the residual catalyst in PBT tends to cause problems such as increase in an end carboxyl group concentration in PBT and acceleration of reactions with discoloration of PBT, resulting in thermal degradation of PBT. The thermal degradation of PBT tends to be caused by not only heat history upon production of PBT, but also heat history upon kneading or molding. Therefore, from the standpoint of preventing occurrence of the thermal degradation, it is preferred that the polymerization, kneading process or molding process is conducted at a temperature as low as possible. However, when it is intended to produce PBT having the same molecular weight at a low polymerization temperature, the polymerization time must be inevitably prolonged, so that the problems concerning the heat history still remain unsolved.

On the other hand, PBT having the same molecular weight may be produced at a low temperature for a short polymerization time by using an increased amount of the catalyst. However, since the catalyst tends to promote the increase of the impurities (fish eyes) content by deactivation thereof, discoloration or deterioration of PBT as described above, this method also fails to produce products having a good quality.

The problems of the above conventional techniques are summarized as follows. That is, when the amount of the catalyst used is reduced, the polymerization temperature is lowered and the polymerization time is shortened, PBT obtained has only a low molecular weight. On the other hand, when it is intended to obtain PBT having a high molecular weight while preventing occurrence of the thermal degradation, it is inevitably required to conduct the solid-phase polymerization. However, PBT produced by the solid-phase polymerization has the problems concerning the fluctuation upon melt-extruding, fish eyes as described above. In particular, when the low temperature is used upon kneading or molding to prevent occurrence of the thermal degradation, it may be more difficult to intimately mix the surface layer portion (i.e., high-molecular weight components) and central portion (i.e., low-molecular weight components) of the pellets with each other, thereby rather large causing these problems.

Further, in recent years, PBT has been increasingly applied to films, etc., for food packages. PBT contains as end groups thereof, not only hydroxyl groups and carboxyl groups, but also residual methoxycarbonyl groups derived from raw materials. The end methoxycarbonyl groups tend to generate methanol as well as formaldehyde or formic acid as oxides of methanol upon exposure to heat during the molding process, heating in an electronic oven, or enzyme, acid or base contained in the food, thereby causing problems due to toxicity thereof. In addition, the formic acid generated tends to damage polymerization apparatuses, molding apparatuses and vacuum-related apparatuses which are made of a metal. Therefore, it has been demanded to reduce the amount of such end groups in PBT.
Patent literature 1: Japanese Patent Application Laid-Open (KOKAI) No. 2003-73488

### DISCLOSURE OF THE INVENTION

### Subject to be Solved by the Invention

Under the circumstances of the above, the present invention has been achieved, and an object of the present invention is to provide a PBT pellet capable of producing a molded product which is excellent in color tone, hydrolysis resistance, transparency and molding stability, and has a less content of impurities.

### Means for Solving the Subject

As a result of the present inventors' earnest study to attain the above aim, it has been found that the above problems can be solved by such PBT in which a titanium catalyst content and end methoxycarbonyl group concentration therein are respectively reduced to not more than specific values, and the difference in intrinsic viscosity between a central portion and a surface layer portion of pellets produced therefrom is controlled to not more than a specific value. The present invention has been attained on the basis of this finding.

To accomplish the aim, in a first aspect of the present invention, there is provided a polybutylene terephthalate pellet comprising polybutylene terephthalate containing titanium in an amount of not more than 90 ppm by weight, as calculated as titanium atom, and having an end methoxycarbonyl group concentration of not more than 0.5 μeq/g, wherein said pellet has an average intrinsic viscosity of 0.90 to 2.00 dL/g, and a difference in intrinsic viscosity between a central portion and a surface layer portion of the pellet is not more than 0.10 dL/g.

In a second aspect of the present invention, there is provided a compound product produced using the polybutylene terephthalate pellet as defined in the above as at least a part of a raw material thereof. In a third aspect of the present invention, there is provided a process for producing a compound product, comprising kneading the polybutylene terephthalate pellet as defined in the above as at least a part of a raw material thereof, by an extruder.

In a fourth aspect of the present invention, there is provided a molded product produced using the compound product as defined in the above as at least a part of a raw molding material thereof. In a fifth aspect of the present invention, there is provided a process for producing a molded product, comprising molding the compound product as defined in the above as at least a part of a raw molding material thereof, by an injection molding machine.

In a sixth aspect of the present invention, there is provided a molded product produced using the polybutylene terephthalate pellet as defined in the first aspect as at least a part of a raw material thereof. In a seventh aspect of the present invention, there is provided a process for producing a molded product, comprising molding the polybutylene terephthalate pellet as defined in the first aspect as at least a part of a raw material thereof, by an extruder.

### EFFECT OF THE INVENTION

According to the present invention, there can be provided a PBT molded product which is excellent in color tone, hydrolysis resistance, transparency and molding stability, and exhibits a less content of impurities, as well as a process for producing the molded product.

### BRIEF DESCRIPTION OF THE DRAWINGS

FIG. 1 is an explanatory view showing an example of an esterification reaction process or a transesterification reaction process adopted in the present invention.

FIG. 2 is an explanatory view showing an example of a polycondensation reaction process adopted in the present invention.

### EXPLANATION OF REFERENCE NUMBER

1: Raw material feed line

2: Recirculation line

3: Catalyst feed line

4: Discharge line

5: Distillate line

6: Discharge line

7: Circulation line

8: Discharge line

9: Gas discharge line

10: Condensate line

11: Discharge line

12: Circulation line

13: Discharge line

14: Vent line

A: Reaction vessel

B: Discharge pump

C: Rectifying column

D and E: Pump

F: Tank

G: Condenser

L1, L3 and L5: Discharge line

L2, L4 and L6: Vent line

a: First polycondensation reaction vessel

d: Second polycondensation reaction vessel

k: Third polycondensation reaction vessel

c, e and m: Discharging gear pump

g: Die head

h: Rotary cutter

### BEST MODE FOR CARRYING OUT THE INVENTION

The present invention is described in detail below. The preferred embodiments of the present invention as described below are only typical and illustrative, and, therefore, the present invention is not limited thereto.

In the present invention, PBT has such a structure that dicarboxylic acid units and diol units are bonded to each other to form an ester thereof, in which not less than 50% of the dicarboxylic acid units are composed of terephthalic acid units, and not less than 50% of the diol units are composed of 1,4-butanediol units. The content of the terephthalic acid units in the whole dicarboxylic acid units is preferably not less than 70%, more preferably not less than 80%, still more preferably not less than 95%, and the content of the 1,4-butanediol units in the whole diol units is preferably not less than 70%, more preferably not less than 80%, still more preferably not less than 95%. When the content of the terephthalic acid units or the 1,4-butanediol units is less than 50%, the crystallization velocity of PBT tends to be deteriorated, resulting in poor moldability.

In the present invention, the dicarboxylic acid components other than terephthalic acid are not particularly limited. Examples of the dicarboxylic acid components other than terephthalic acid may include aromatic dicarboxylic acids such as phthalic acid, isophthalic acid, 4,4′-diphenyldicarboxylic acid, 4,4′-diphenyletherdicarboxylic acid, 4,4′-benzophenonedicarboxylic acid, 4,4′-diphenoxyethanedicarboxylic acid, 4,4′-diphenylsulfonedicarboxylic acid and 2,6-naphthalenedicarboxylic acid; alicyclic dicarboxylic acids such as 1,2-cyclohexanedicarboxylic acid, 1,3-cyclohexanedicarboxylic acid and 1,4-cyclohexanedicarboxylic acid; aliphatic dicarboxylic acids such as malonic acid, succinic acid, glutaric acid, adipic acid, pimelic acid, suberic acid, azelaic acid and sebacic acid; or the like. These dicarboxylic acid components may be introduced into the polymer skeleton using dicarboxylic acids or dicarboxylic acid derivatives such as dicarboxylic acid esters and dicarboxylic acid halides as raw materials.

In the present invention, the diol components other than 1,4-butanediol are not particularly limited. Examples of the diol components other than 1,4-butanediol may include aliphatic diols such as ethylene glycol, diethylene glycol, polyethylene glycol, 1,2-propanediol, 1,3-propanediol, polypropylene glycol, polytetramethylene glycol, dibutylene glycol, 1,5-pentanediol, neopentyl glycol, 1,6-hexanediol and 1,8-octanediol; alicyclic diols such as 1,2-cyclohexanediol, 1,4-cyclohexanediol, 1,1-cyclohexane dimethylol and 1,4-cyclohexane dimethylol; aromatic diols such as xylylene glycol, 4,4′-dihydroxybiphenyl, 2,2-bis(4-hydroxyphenyl)propane and bis(4-hydroxyphenyl)sulfone; or the like.

In the present invention, as comonomers that are copolymerizable with the dicarboxylic acid components and the diol components, there may also be used monofunctional components such as hydroxycarboxylic acids, e.g., lactic acid, glycolic acid, m-hydroxybenzoic acid, p-hydroxybenzoic acid, 6-hydroxy-2-naphthalenecarboxylic acid and p-β-hydroxyethoxybenzoic acid, alkoxycarboxylic acids, stearyl alcohol, benzyl alcohol, stearic acid, benzoic acid, t-butylbenzoic acid and benzoylbenzoic acid; tri- or more polyfunctional components such as tricarballylic acid, trimellitic acid, trimesic acid, pyromellitic acid, gallic acid, trimethylol ethane, trimethylol propane, glycerol and pentaerythritol; or the like.

The PBT of the present invention can be produced by using 1,4-butanediol and terephthalic acid (or dialkyl terephthalate) as raw materials and a titanium compound as a catalyst.

Specific examples of the titanium catalyst may include inorganic titanium compounds such as titanium oxide and titanium tetrachloride; titanium alcoholates such as tetramethyl titanate, tetraisopropyl titanate and tetrabutyl titanate; titanium phenolates such as tetraphenyl titanate; or the like. Of these titanium catalysts, preferred are tetraalkyl titanates, and more preferred is tetrabutyl titanate.

In addition to titanium, tin may be used as a catalyst. Tin may be usually used in the form of a tin compound. Specific examples of the tin compound may include dibutyl tin oxide, methylphenyl tin oxide, tetraethyl tin, hexaethyl ditin oxide, cyclohexahexyl ditin oxide, didodecyl tin oxide, triethyl tin hydroxide, triphenyl tin hydroxide, triisobutyl tin acetate, dibutyl tin diacetate, diphenyl tin dilaurate, monobutyl tin trichloride, tributyl tin chloride, dibutyl tin sulfide, butylhydroxy tin oxide, methylstannoic acid, ethylstannoic acid, butylstannoic acid, or the like.

The tin tends to deteriorate a color tone of the resultant PBT. Therefore, the amount of the tin added is usually not more than 200 ppm by weight, preferably not more than 100 ppm by weight, more preferably not more than 10 ppm by weight, calculated as tin atom. Most preferably, no tin should be added to the PBT.

In addition to titanium, there may also be used a reaction aid or a co-catalyst, e.g., magnesium compounds such as magnesium acetate, magnesium hydroxide, magnesium carbonate, magnesium oxide, magnesium alkoxide and magnesium hydrogen phosphate; calcium compounds such as calcium acetate, calcium hydroxide, calcium carbonate, calcium oxide, calcium alkoxide and calcium hydrogen phosphate; antimony compounds such as antimony trioxide; germanium compounds such as germanium dioxide and germanium tetraoxide; manganese compounds; zinc compounds; zirconium compounds; cobalt compounds; phosphorus compounds such as orthophosphoric acid, phosphorous acid, hypophosphorous acid, polyphosphoric acid and esters or metal salts of these compounds; sodium hydroxide; sodium benzoate; or the like.

One of the features of the PBT according to the present invention lies in that the PBT contains titanium in an amount of not more than 90 ppm by weight (calculated as a titanium atom). Meanwhile, the amount of titanium means a weight percentage of titanium atom based on the PBT.

In the present invention, the lower limit of the titanium content is usually 10 ppm by weight, preferably 15 ppm by weight, more preferably 20 ppm by weight, still more preferably 25 ppm by weight, whereas the upper limit of the titanium content is preferably 80 ppm by weight, more preferably 70 ppm by weight, still more preferably 50 ppm by weight, further still more preferably 40 ppm by weight, most preferably 33 ppm by weight. When the titanium content is more than 90 ppm by weight, the resultant polybutylene terephthalate tends to undergo not only deteriorated color tone due to heat history upon producing PBT, kneading or molding films or sheets and deteriorated hydrolysis resistance due to increase in end carboxyl group concentration in the PBT, but also increase in fish eyes due to residual catalyst. These defects tend to become more remarkable when the catalyst is deactivated. On the other hand, when the titanium content is excessively too small, the polymerization degree of the PBT tends to be deteriorated. As a result, since it is required to raise the polymerization temperature, the resultant PBT tends to be deteriorated in color tone and hydrolysis resistance.

The contents of metals such as titanium atom in the resultant PBT may be determined by recovering these metals from the polymer by a method such as wet-ashing, and then measuring the amounts of the metals by a methods such as atomic emission spectrometric method, atomic absorption spectrometric method, inductively coupled plasma (ICP) method, etc.

The end carboxyl group concentration in the PBT of the present invention is usually 0.1 to 50 μeq/g, preferably 1 to 40 μeq/g, more preferably 5 to 30 μeq/g, still more preferably 10 to 25 μeq/g. When the end carboxyl group concentration is too high, the resultant PBT tends to be deteriorated in hydrolysis resistance. In addition, although the amount of the end carboxyl groups contained in PBT tends to be increased due to the heat history upon molding the PBT into films or sheets, in the case where the PBT is mixed with other resins having a less end carboxyl group content, the amount of the end carboxyl groups per unit weight of the films or sheets produced may be decreased in some cases. The end carboxyl group concentration in the films or sheet as final products is usually 0.1 to 50 μeq/g, preferably 1 to 40 μeq/g, more preferably 5 to 30 μeq/g, still more preferably 10 to 25 μeq/g based on a unit weight of the films or sheets including the weight of the other resins.

The end carboxyl group concentration in the PBT may be determined by subjecting a solution prepared by dissolving the PBT in an organic solvent to titration using an alkali solution such as a sodium hydroxide solution.

Also, the end vinyl group concentration in the PBT of the present invention is usually 0.1 to 15 μeq/g, preferably 0.5 to 10 μeq/g, more preferably 1 to 8 μeq/g. When the end vinyl group concentration is too high, the PBT tends to be deteriorated in color tone. Since the end vinyl group concentration tends to be further increased by heat history upon molding, in the case where the molding temperature is high or the production process includes a recycling step, the deterioration in color tone of the PBT tends to become more remarkable.

The PBT may sometimes contain, in addition to the above end hydroxyl group, carboxyl group and vinyl group, residual end methoxycarbonyl groups derived from the raw materials. In particular, in the case where dimethyl terephthalate is used as the raw material, the amount of such residual end methoxycarbonyl groups tends to be increased. Meanwhile, the end methoxycarbonyl groups tend to generate methanol, formaldehyde or formic acid by heat produced upon molding of films or sheets, resulting in problems concerning toxicity of these compounds, in particular, when used in food-relating applications. Further, the formic acid tends to cause corrosion of molding apparatuses and vacuum-related apparatuses attached thereto which are made of metals. Consequently, the PBT of the present invention is required to have an end methoxycarbonyl group concentration of usually not more than 0.5 μeq/g, preferably not more than 0.3 μeq/g, more preferably not more than 0.2 μeq/g, still more preferably not more than 0.1 μeq/g.

The above end vinyl group and end methoxycarbonyl group concentrations can be qualitatively determined by subjecting a solution prepared by dissolving the PBT in a mixed solvent containing heavy chloroform and hexafluoroisopropanol at a volume ratio of 7:3 to ¹H-NMR measurement. Upon the ¹H-NMR measurement, in order to prevent signals attributed to the respective end groups from being overlapped with those attributed to the solvent, a trace amount of a basic component such as heavy pyridine may be added to the solution to be measured.

The PBT of the present invention is required to have an intrinsic viscosity of 0.90 to 2.00 dL/g, preferably 1.00 to 1.80 dL/g, more preferably 1.10 to 1.40 dL/g, still more preferably 1.20 to 1.30 dL/g. When the intrinsic viscosity of the PBT is less than 0.90 dL/g, the PBT tends to suffer from severe drawdown from a die upon extrusion molding, resulting in not only poor moldability of the PBT but also insufficient mechanical strength of the molded product produced therefrom. When the intrinsic viscosity of the PBT is more than 2.00 dL/g, the PBT tends to have a too high melt viscosity and, therefore, tends to be deteriorated in fluidity, resulting in poor moldability of the PBT as well as poor surface properties of the molded product produced therefrom. The above intrinsic viscosity is such a value measured at 30° C. using a mixed solution containing phenol and tetrachloroethane at a weight ratio of 1:1 as a solvent. In addition, the average intrinsic viscosity used in the present invention means an intrinsic viscosity of a solution prepared by dissolving the whole PBT pellets in the solvent.

The difference in intrinsic viscosity between the central portion and surface layer portion of the respective PBT pellets of the present invention is required to be not more than 0.10 dL/g, preferably not more than 0.07 dL/g, more preferably not more than 0.05 dL/g, still more preferably not more than 0.03 dL/g. When the difference in intrinsic viscosity between the central portion and surface layer portion of the respective pellets is more than 0.10 dL/g, there tend to arise problems upon molding including not only increase in fish eyes and tearing upon stretching, but also increase in torque load applied to extruders and fluctuation of the torque, resulting in unstable quality of the resultant products.

In the present invention, the difference in intrinsic viscosity between the central portion and surface layer portion of the respective pellets means a difference in intrinsic viscosity between two specific portions, i.e., a portion extending outwardly from a center of the respective pellets up to reaching 10% of the weight of the respective pellets and a portion extending inwardly from an outer periphery of the respective pellets up to reaching 10% of the weight of the respective pellets. The intrinsic viscosity of each of the central portion and the surface layer portion of the respective pellets may be determined as follows. That is, the PBT pellets are allowed to stand in a solvent into which the pellets are soluble, and the solvent is periodically replaced with a fresh solvent. This replacing procedure is repeated to obtain fractions of the PBT solution in which each pellet is successively dissolved from the surface layer portion toward the central portion thereof. The solvent is removed from the first fraction obtained upon initiation of dissolving the pellets and the last fraction in which the last central part thereof is completely dissolved, respectively, to separately obtain PBT contained in the surface layer portion of the pellet and PBT contained in the central portion thereof, and measure an intrinsic viscosity of each PBT. The difference in intrinsic viscosity between the central portion and surface layer portion of the respective pellets can be determined as the difference between these measured values. In operation, in order to strictly obtain the difference in intrinsic viscosity between a complete central portion and a complete surface layer portion of the respective pellets, it is required to repeat recovery of fractions infinite times. Therefore, in the present invention, the central portion of the respective pellets is defined as such a portion extending outwardly from a center of the respective pellets up to reaching 10% of the weight of the respective pellets, whereas the surface layer portion thereof is defined as such a portion extending inwardly from an outer periphery of the respective pellets up to reaching 10% of the weight of the respective pellets.

The method for producing the PBT is not particularly limited as long as the obtained PBT satisfies the specific conditions of the present invention. In order to obtain PBT having a high molecular weight suitable for production of films, sheets or filaments which is decreased in fish eyes while preventing deterioration in color tone and increase in end carboxyl group concentration therein, it is preferred that the melt-polymerization is conducted at a low temperature for a short period of time while controlling the amount of the catalyst added to not more than 90 ppm by weight. However, as described above, in general, in the case where the melt polymerization is conducted at a low temperature for a short period of time using a reduced amount of the catalyst, it may be difficult to produce the PBT having a high molecular weight suitable for production of films, sheets or filaments. For this reason, as an example of the method of producing PBT suitable for the purposes of the present invention, there may be exemplified a method of preventing the catalyst from being deactivated and simultaneously improving renewal of the boundary face upon the polycondensation, thereby lowering the reaction pressure.

When the catalyst is deactivated, the precipitation tends to be caused, resulting in increase in solution haze of the PBT. The solution haze of the PBT used in the present invention is defined as a turbidity value of a solution prepared by dissolving 2.7 g of the PBT in 20 mL of a mixed solvent containing phenol and tetrachloroethane at a weight ratio of 3:2. The solution haze defined as a turbidity value is usually not more than 5%, preferably not more than 3%, more preferably not more than 2%, still more preferably not more than 1%. The solution haze increased due to deactivation of the catalyst, causes the deterioration of the transparency in the films, sheets or filaments, resulting in considerable damage to commercial value of these products.

Next, an example of a direct polymerization method of the PBT using terephthalic acid as a raw material according to the present invention is explained. From the standpoints of supply of the raw materials and recovery or due-out of the resultant polymer, the process for producing the PBT is generally classified into a batch method and a continuous method. Further, the PBT production process may be performed such that after conducting the initial esterification reaction by a continuous method, the polycondensation following the esterification reaction may be conducted by a batch method. On the contrary, after conducting the initial esterification reaction by a batch method, the polycondensation following the esterification reaction may be conducted by a continuous method. In the present invention, from the standpoints of stable productivity, stable quality of products and improving effects by the present invention, there may be suitably used such a method of continuously conducting the esterification reaction while continuously supplying the raw materials. Further, in the present invention, not only the esterification reaction but also the polycondensation reaction following the esterification reaction are preferably performed by a continuous method.

In the present invention, there is preferably adopted such a process in which terephthalic acid is continuously esterified with 1,4-butanediol in the presence of the titanium catalyst in an esterification reaction vessel while supplying at least a part of the 1,4-butanediol independently of the terephthalic acid to the reaction vessel. More specifically, in the present invention, in order to decrease the haze or impurities due to the catalyst and prevent deterioration in activity of the catalytic, a part of 1,4-butanediol is supplied into the esterification reaction vessel separately from 1,4-butanediol supplied together with the terephthalic acid in the form of a raw slurry or solution, and independently of the terephthalic acid. The 1,4-butanediol supplied independently of the terephthalic acid is hereinafter occasionally referred to merely as “separately supplied 1,4-butanediol”.

As the above “separately supplied 1,4-butanediol”, there may be used fresh 1,4-butanediol having no relation to the process. Alternatively, the “separately supplied 1,4-butanediol” may be such 1,4-butanediol which is distilled off from the esterification reaction vessel, collected by a condenser, etc., and then circulated to the reaction vessel directly or after temporarily storing the diol in a tank, etc. Also, the temporarily stored 1,4-butanediol may be purified by removing impurities therefrom and then supplied as a high-purity 1,4-butanediol. Hereinafter, the “separately supplied 1,4-butanediol” which is collected by a condenser, etc., is occasionally referred to merely as a “recirculated 1,4-butanediol”. From the standpoints of effective utilization of sources and simplicity of facilities used, the “separately supplied 1,4-butanediol” is preferably the “recirculated 1,4-butanediol”.

The 1,4-butanediol distilled off from the esterification reaction vessel usually contains, in addition to 1,4-butanediol itself, other components such as water, tetrahydrofuran (hereinafter referred to merely as “THF”), dihydrofuran, alcohol or the like. Therefore, the 1,4-butanediol distilled off from the reaction vessel is preferably purified to remove the other components such as water and THF therefrom while or after collecting the 1,4-butanediol by a condenser, etc., prior to circulating and returning the 1,4-butanediol to the reaction vessel.

In the present invention, not less than 10% by weight of the “separately supplied 1,4-butanediol” is preferably directly returned to a liquid phase portion of the reaction solution. Here, the liquid phase portion of the reaction solution means a portion located on a liquid phase side with respect to a boundary face between gas and liquid in the esterification reaction vessel. The direct return of the 1,4-butanediol to the liquid phase portion of the reaction solution means that the “separately supplied 1,4-butanediol” is directly returned to the liquid phase portion using a conduit, etc., without passing through the gas phase portion in the reaction vessel. The amount of the “separately supplied 1,4-butanediol” directly supplied to the liquid phase portion of the reaction solution is usually not less than 30% by weight, preferably not less than 50% by weight, more preferably not less than 80% by weight, still more preferably not less than 90% by weight. When the amount of the “separately supplied 1,4-butanediol” directly supplied to the liquid phase portion of the reaction solution is too small, the titanium catalyst tends to be deactivated.

The temperature of the “separately supplied 1,4-butanediol” to be supplied to the reaction vessel is usually in the range of 50 to 220° C., preferably 100 to 200° C., more preferably 150 to 190° C. When the temperature of the “separately supplied 1,4-butanediol” to be supplied is too high, the amount of THF by-produced tends to be increased. When the temperature of the “separately supplied 1,4-butanediol” is too low, the thermal load tends to be increased, resulting in occurrence of energy loss.

Also, in the present invention, in order to prevent deactivation of the catalyst, not less than 10% by weight of the titanium catalyst used in the esterification reaction is preferably directly supplied to the liquid phase portion of the reaction solution independently of the terephthalic acid. Here, the liquid phase portion of the reaction solution means a portion located on a liquid phase side with respect to a boundary face between gas and liquid in the esterification reaction vessel. The direct supply of the catalyst to the liquid phase portion of the reaction solution means that the titanium catalyst is directly supplied to the liquid phase portion using a conduit, etc., without passing through the gas phase portion in the reaction vessel. The amount of the titanium catalyst directly added to the liquid phase portion of the reaction solution is usually not less than 30% by weight, preferably not less than 50% by weight, more preferably not less than 80% by weight, still more preferably not less than 90% by weight.

The titanium catalyst may be supplied to the liquid phase portion of the reaction solution in the esterification reaction vessel either directly or in the form of a solution prepared by dissolving the catalyst in a solvent, etc. In order to stabilize the amount of the catalyst supplied and reduce adverse influences such as deterioration in quality due to heat transferred from a heating medium jacket of the reaction vessel, the catalyst is preferably diluted with a solvent such as 1,4-butanediol. In this case, the catalyst concentration in the diluted catalyst solution is in the range of usually 0.01 to 20% by weight, preferably 0.05 to 10% by weight, more preferably 0.08 to 8% by weight when calculated as a concentration of the titanium catalyst based on the total weight of the solution. Further, from the standpoint of reducing the impurities, the water concentration in the catalyst solution is in the range of usually 0.05 to 1.0% by weight. The catalyst solution may be prepared at a temperature of usually 20 to 150° C., preferably 30 to 100° C., more preferably 40 to 80° C. in order to prevent the catalyst from being deactivated or coagulated. Further, the catalyst solution is preferably mixed with the separately supplied 1,4-butanediol in a conduit, etc, and then supplied to the esterification reaction vessel from the standpoint of preventing deterioration in quality, precipitation and deactivation of the catalyst.

An example of the continuous method is as follows. That is, the dicarboxylic acid component containing terephthalic acid as a main component and the diol component containing 1,4-butanediol as a main component are mixed with each other in a raw material mixing tank to prepare a slurry. Then, the slurry is fed to a single esterification reaction vessel or a plurality of esterification reaction vessels where the esterification reaction thereof is continuously conducted in the presence of the titanium catalyst. The thus obtained esterification reaction product in the form of an oligomer is transferred into a single polycondensation reaction vessel or a plurality of polycondensation reaction vessels where the polycondensation reaction thereof is conducted preferably in a continuous manner in the presence of a polycondensation catalyst under stirring.

The esterification reaction temperature is usually 180 to 260° C., preferably 200 to 245° C., more preferably 210 to 235° C.; the esterification reaction pressure (absolute pressure) is usually 10 to 133 kPa, preferably 13 to 101 kPa, more preferably 60 to 90 kPa; and the esterification reaction time is usually 0.5 to 10 hours, preferably 1 to 6 hours. Also, the polycondensation reaction temperature is usually 210 to 280° C., preferably 220 to 265° C., more preferably 230 to 245° C.; the polycondensation reaction pressure is usually not more than 27 kPa, preferably not more than 20 kPa, more preferably not more than 13 kPa; and the polycondensation reaction time is usually 2 to 15 hours, preferably 3 to 10 hours. In the polycondensation stage, a fresh polycondensation catalyst may be added to the reaction system, or the catalyst used in the esterification reaction may be directly used as the polycondensation catalyst without addition of the fresh catalyst. The polymer thus obtained by the polycondensation reaction is usually withdrawn from a bottom of the polycondensation reaction vessel, delivered into an extrusion die, extruded therefrom into strands, and then cut into pellets using a cutter while or after water-cooling.

In the present invention, the molar ratio between terephthalic acid and 1,4-butanediol preferably satisfies the following formula (1):
BM/TM=1.1 to 5.0 (mol/mol) (1)
wherein BM is the number of moles of 1,4-butanediol supplied from outside to the esterification reaction vessel per unit time; and TM is the number of moles of terephthalic acid supplied from outside to the esterification reaction vessel per unit time.

The above “1,4-butanediol supplied from outside to the esterification reaction vessel” means a sum of 1,4-butanediols entering from outside into an inside of the reaction vessel, namely a sum of 1,4-butanediol supplied together with terephthalic acid in the form of a raw slurry or solution, 1,4-butanediol supplied independently of the terephthalic acid, 1,4-butanediol used as the solvent for the catalyst, etc.

When the molar ratio BM/TM is less than 1.1, deterioration in conversion rate and deactivation of the catalyst tend to be caused. When the molar ratio BM/TM is more than 5.0, not only deterioration in thermal efficiency but also increase in amount of by-products such as THF tend to be caused. The molar ratio BM/TM is preferably 1.5 to 4.5, more preferably 2.0 to 4.0, still more preferably 3.1 to 3.8.

In the present invention, the esterification reaction is preferably conducted at a temperature not lower than the boiling point of 1,4-butanediol in order to shorten the reaction time. The boiling point of 1,4-butanediol varies depending upon the reaction pressure, and is 230° C. under 101.1 kPa (atmospheric pressure) and 205° C. under 50 kPa.

As the esterification reaction vessel, there may be used known reaction vessels, specifically, there may be used any of vertical agitation complete mixing tanks, vertical thermal convection-type mixing tanks, tower-type continuous reaction vessels, etc. The esterification reaction vessel may be constituted by a single vessel or a plurality of vessels of the same or different type connected in series or in parallel. Among these reaction vessels, preferred are those reaction vessels equipped with a stirrer. As the stirrer, there may be used not only ordinary stirring apparatuses constituted from a power section, a bearing, an axis and agitation blades, but also high-speed rotation type stirring apparatuses such as turbine-stator type high-speed rotating stirrers, disk mill type stirrers and rotor mill type stirrers.

The stirring method is not particularly limited. In the present invention, there may be used not only ordinary stirring methods in which the reaction solution in the reaction vessel is directly stirred from upper, lower and side portions of the reaction vessel, but also the method of discharging a part of the reaction solution out of the reaction vessel through a conduit, etc., stirring the solution using a line mixer, etc., and then circulating the reaction solution to the reaction vessel.

The kinds of agitation blades may be appropriately selected from known blades. Specific examples of the agitation blades may include propeller blades, screw blades, turbine blades, fan turbine blades, disk turbine blades, Faudler blades, full zone blades, maxblend blades, etc.

Upon production of the PBT, there may be usually used a plurality of reaction vessels, preferably 2 to 5 reaction vessels, through which the polymer obtained therein is successively increased in its molecular weight. Following the initial esterification reaction, the polycondensation reaction may be usually successively conducted.

In the polycondensation reaction process of the PBT, there may be used a single reaction vessel or a plurality of reaction vessels. The polycondensation reaction process is preferably conducted using a plurality of reaction vessels. The types of the reaction vessels used in the polycondensation reaction process may be any of vertical agitation complete mixing tanks, vertical thermal convection-type mixing tanks, tower-type continuous reaction vessels, or the combination of these reaction vessels. Among these reaction vessels, preferred are those reaction vessels equipped with a stirrer. As the stirrer, there may be used not only ordinary stirring apparatuses constituted from a power section, a bearing, an axis and agitation blades, but also high-speed rotation type stirring apparatuses such as turbine-stator type high-speed rotating stirrers, disk mill type stirrers and rotor mill type stirrers.

The stirring method is not particularly limited. In the present invention, there may be used not only ordinary stirring methods in which the reaction solution in the reaction vessel is directly stirred from upper, lower and side portions of the reaction vessel, but also the method of discharging a part of the reaction solution out of the reaction vessel through a conduit, etc., stirring the solution using a line mixer, etc., and then circulating the reaction solution to the reaction vessel. In particular, it is recommended to use as at least one of the polycondensation reaction vessels, such a horizontal-type reactor having a horizontal rotation axis which is excellent in surface renewal property and self-cleanability.

Also, in order to prevent discoloration or deterioration of the polymer as well as increase in end groups such as vinyl groups, at least one of the reaction vessels is preferably operated under a high vacuum condition, i.e., under a pressure of usually not more than 1.3 kPa, preferably not more than 0.5 kPa, more preferably not more than 0.3 kPa at a temperature of usually 225 to 255° C., preferably 230 to 250° C., more preferably 233 to 245° C.

In addition, in the polycondensation reaction process of the PBT, after conducting the melt polycondensation to produce PBT having a relatively low molecular weight, e.g., having an intrinsic viscosity of about 0.1 to 1.0 dL/g, the PBT may be successively subjected to solid-phase polymerization at a temperature not higher than the melting point of the PBT. In this case, as described above, in the present invention, it is required that the difference in intrinsic viscosity between the surface layer portion and the central portion of respective pellets produced from the PBT is not more than 0.10 dL/g.

Since the PBT of the present invention is extremely reduced in content of impurities derived from the catalyst, the procedure for removal of the impurities is not particularly required. However, by disposing a filter in a flow path for the polymer precursor or polymer, it is possible to obtain such a polymer having a more excellent quality. In the present invention, for the above-described reasons, in the case where the filter having the same mesh size as that used in the conventional PBT production facilities is employed, a service life thereof up to its replacement can be prolonged. Also, if the service life up to the replacement is set to the same period, it is possible to dispose a filter having a smaller mesh size.

However, when the filter is disposed on an excessively upstream side of the production process, it may be difficult to remove impurities formed on a downstream side thereof. On the contrary, when the filter is disposed on a high-viscosity downstream side of the production process, the filter tends to suffer from large pressure loss. Therefore, in order to maintain a suitable flow amount of the fluid, it is required to considerably increase the mesh size or filtering area of the filter as well as a scale of the facilities such as conduits. In addition, since the filter undergoes a high shear force when the fluid is passed therethrough, the PBT tends to be inevitably deteriorated in quality by heat generation due to the shearing. For this reason, the filter may be selectively disposed at the position where the PBT or the precursor thereof has an intrinsic viscosity of usually 0.10 to 1.20 dL/g, preferably 0.20 to 1.00 dL/g, more preferably 0.50 to 0.90 dL/g.

As the material of the filter, there may be used any of metal winding, laminated metal mesh, metallic non-woven fabric, porous metal plate or the like. Among these materials, laminated metal mesh and metallic non-woven fabric are preferred from the standpoint of filtration accuracy. In particular, the use of filters having meshes which are fixed by sintering treatment are more preferred. The filter may have any suitable shape such as basket type, disk type, leaf disk type, tube type, flat-cylindrical type and pleated cylindrical type. Also, in order to prevent the operation of the plant from being adversely affected by disposing the filter, a plurality of filters with a switchable structure or an auto screen changer are preferably used.

The absolute filtration accuracy of the filter is not particularly limited, and is usually 0.5 to 200 μm, preferably 1 to 100 μm, more preferably 5 to 50 μm, still more preferably 10 to 30 μm. When the absolute filtration accuracy is too large, the filter may fail to exhibit the effect of reducing impurities in the polymer product. When the absolute filtration accuracy is too small, the deterioration in productivity as well as increase in frequency of replacement of the filter tend to be caused. Here, the absolute filtration accuracy means a minimum particle size of particles which can be completely removed by the filter in a filtration test using a standard particle size product having known and uniform particle sizes such as glass beads.

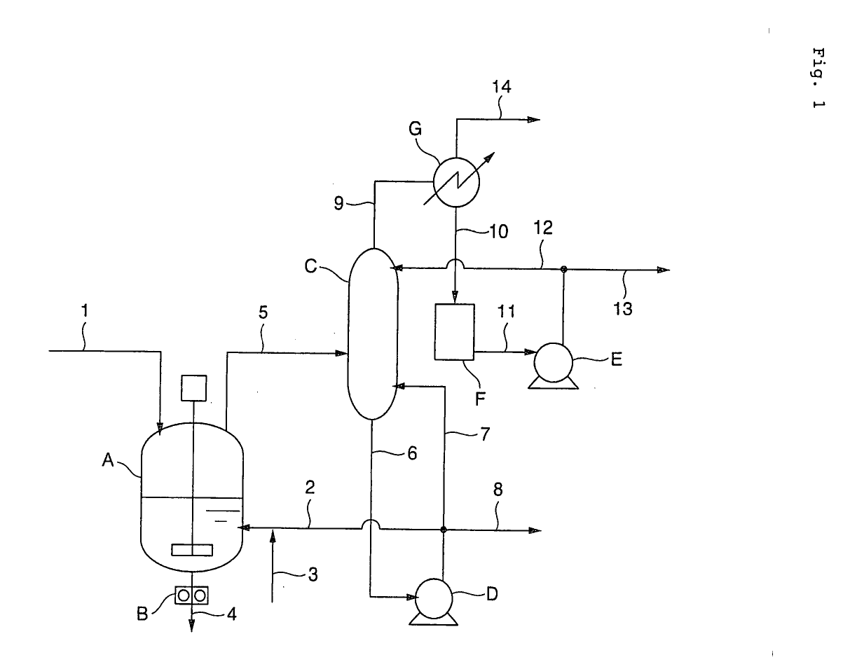

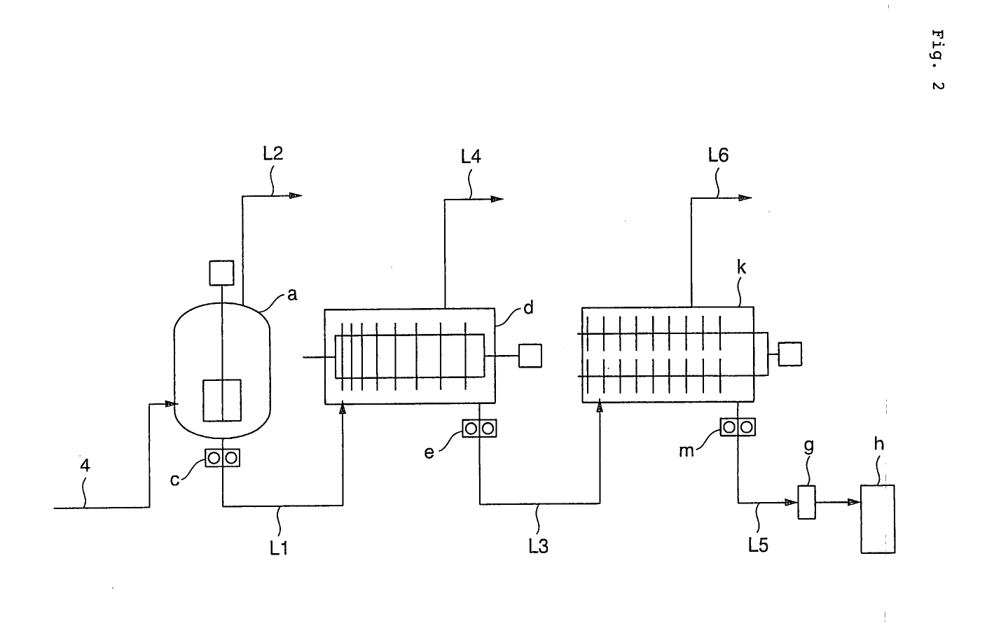

Next, the process for producing the PBT according to the preferred embodiment of the present invention is described below by referring to the accompanying drawings. FIG. 1 is an explanatory view showing an example of an esterification reaction process or a transesterification reaction process used in the present invention. FIG. 2 is an explanatory view showing an example of a polycondensation process used in the present invention.

Referring to FIG. 1, raw terephthalic acid is usually mixed with 1,4-butanediol in a raw material mixing tank (not shown), and the resultant slurry is supplied through a raw material feed line (l) to a reaction vessel (A). On the other hand, when dialkyl terephthalate is used as a raw material, the dialkyl terephthalate is supplied usually in the form of a molten liquid to the reaction vessel (A) independently of 1,4-butanediol. A titanium catalyst is preferably dissolved in 1,4-butanediol in a catalyst preparation tank (not shown) to prepare a catalyst solution, and then supplied through a catalyst feed line (3). In FIG. 1, there is shown such an embodiment in which a recirculation line (2) for feeding the recirculated 1,4-butanediol is connected to the catalyst feed line (3) to mix the recirculated 1,4-butanediol and the catalyst solution with each other, and then the resultant mixture is supplied to a liquid phase portion in the reaction vessel (A).

Gases distilled off from the reaction vessel (A) are delivered through a distillate line (5) to a rectifying column (C) where the gases are separated into a high-boiling component and a low-boiling component. Usually, the high-boiling component is composed mainly of 1,4-butanediol, and the low-boiling component is composed mainly of water and THF in the case of the direct polymerization method.

The high-boiling component separated at the rectifying column (C) is withdrawn through a discharge line (6) and then through a pump (D). Then, a part of the high-boiling component is circulated through the recirculation line (2) to the reaction vessel (A), and another part thereof is returned through a circulation line (7) to the rectifying column (C). Further, an excess of the high-boiling component is discharged outside through a discharge line (8). On the other hand, the low-boiling component separated at the rectifying column (C) is withdrawn through a gas discharge line (9), condensed in a condenser (G), and then delivered through a condensate line (10) to a tank (F) in which the condensed low-boiling component is temporarily stored. A part of the low-boiling component collected in the tank (F) is returned to the rectifying column (C) through a discharge line (11), a pump (E) and a circulation line (12), whereas a remaining part of the low-boiling component is discharged outside through a discharge line (13). The condenser (G) is connected to an exhaust apparatus (not shown) through a vent line (14). An oligomer produced in the reaction vessel (A) is withdrawn therefrom through a discharge pump (B) and a discharge line (4).

In the process shown in FIG. 1, although the recirculation line (2) is connected to the catalyst feed line (3), these lines may be disposed independently of each other. Also, the raw material feed line (1) may be connected to the liquid phase portion in the reaction vessel (A).

In the process shown in FIG. 2, the oligomer supplied through the discharge line (4) as shown in FIG. 1 above, is polycondensed under reduced pressure in a first polycondensation reaction vessel (a) to produce a prepolymer, and then supplied through a discharging gear pump (c) and a discharge line (L1) to a second polycondensation reaction vessel (d). In the second polycondensation reaction vessel (d), the polycondensation is further conducted usually under a pressure lower than that in the first polycondensation reaction vessel (a), thereby converting the prepolymer into a polymer. The thus obtained polymer is delivered through a discharging gear pump (e) and a discharge line (L3), and supplied to a third polycondensation reaction vessel (k). The third polycondensation reaction vessel (k) is a horizontal type reaction vessel constituted from a plurality of agitation blade blocks, more specifically, equipped with twin-axis self-cleaning type agitation blades. The polymer introduced from the second polycondensation reaction vessel (d) to the third polycondensation reaction vessel (k) through the discharge line (L3) is further subjected to polycondensation reaction therein, and then delivered through a discharging gear pump (m) and a discharge line (L5) to a die head (g) from which the polymer is then extruded into molten strands. The obtained strands are cooled with water, etc., and then cut into pellets using a rotary cutter (h). Reference numerals (L2), (L4) and (L6) represent vent lines extending from the first polycondensation reaction vessel (a), the second polycondensation reaction vessel (d) and the third polycondensation reaction vessel (k), respectively.

Next, the compound product comprising the PBT pellet of the present invention is explained. The compound product of the present invention is characterized by using the above PBT pellet as at least a part of a raw material thereof. Here, the “compound product” means a material obtained by kneading a plurality of raw materials, for example, additives such as reinforced fillers such as glass fibers, carbon fibers, glass flakes or the like, plasticizers, colorants, flame retardants, etc., with the PBT pellets. Such a compound product may be used as a molding material of parts for electric appliances, office automation equipments, automobiles or the like.

Examples of additives other than the above-mentioned additives, which may be blended in the compound product of the present invention, may include, in addition to stabilizers such as antioxidants, heat stabilizers, weather-proof agents or the like, lubricants, mold release agents, catalyst deactivators, nucleating agent, crystallization accelerators, ultraviolet absorbers, antistatic agents, foaming agents, impact modifiers, etc.

Further, the compound product of the present invention may be blended, if required, with thermoplastic resins such as polyethylene, polypropylene, polystyrene, polyacrylonitrile, polymethacrylic esters, ABS resins, polycarbonates, polyamides, polyphenylene sulfides, polyethylene terephthalate, liquid crystal polyesters, polyacetal and polyphenylene ethers; and thermosetting resins such as phenol resins, melamine resins, silicone resins and epoxy resins. These thermoplastic and thermosetting resins may be used in the combination of any two or more thereof.

The method of blending the above various fillers, additives and resins is not particularly limited. In the present invention, there may be used the method of blending the respective components with each other using a single- or twin-screw extruder or kneader equipped with a vent port for removal of volatile components to previously prepare the compound product prior to molding process thereof, or the method of blending the respective components with each other upon molding. Among of the methods, preferred is the method of previously preparing the compound product prior to molding process, because large improved effects of the present invention can be achieved. The respective components together with the additional optional components can be supplied to the kneader machine either simultaneously or sequentially. The amount of the respective components blended may be selected according to the aimed applications of the compound product, etc.

The kneading temperature of the compound product is not particularly limited. However, when the kneading temperature is too high, the resultant compound product tends to suffer from deteriorated color tone, increase in end carboxyl group concentration and further deteriorate the hydrolysis resistance. Therefore, the kneading temperature of the compound product is usually not more than 270° C., preferably not more than 265° C., more preferably not more than 260° C. Since the difference in intrinsic viscosity therebetween of the raw PBT of the present invention is small, which the difference thereof is the cause of the increase of the loading of the extruder, fluctuation thereof or the like, even though the raw PBT pellet is kneaded at such a low temperature, the loading of the extruder become small and fluctuation thereof is small, thereby achieving both decrease of fish eyes and prevention of thermal degradation upon molding which have been difficult to simultaneously overcome by the convention methods.

The parts for electric appliances, office automation equipments, automobiles or the like can be produced by molding a raw material using the compound product as at least a part of the raw molding material, by an injection molding machine according to the present invention. In this case, the melting temperature of the compound product (concretely, the melting temperature of the resin therein) is selected from the same range mentioned the above. Further, recycled material can be used as at least a part of the raw molding material, in the same way of a process for producing the molded product using an extruder mentioned the later.

Next, the molded product comprising the PBT pellet according to the present invention is explained. The molded product of the present invention is characterized by using the above PBT pellet as at least a part of a raw molding material thereof. Example of the configuration of the molded product may include films, sheets and filaments. Meanwhile, in the present invention, the films or sheets both mean such molded products which are spread two-dimensionally, but are different in thickness from each other. The boundary thickness between the films and sheets is 1/100 inch (0.254 mm), since this thickness frequently forms a boundary between applications of these PBT products.

The method for production of the films or sheets is not particularly limited, and various known methods may be used therefor. Examples of the production method may include a T-die casting method, an air-cooling inflation method, a water-cooling inflation method and a calendering method. Further, a multilayered film may be produced using a known multilayer forming apparatus such as a multi-manifold T-die, a stack plate die, a feed block and a multilayer inflation die, etc. These methods may be conducted after drying the PBT resin and then, if required, blending additives such as other resins and thermal stabilizers therein.

Further, if required, according to known methods, the films or sheets may be subjected to monoaxial stretching or biaxial stretching to obtain a stretched film. The type of the biaxial stretching process may be either simultaneous biaxial stretching or sequential biaxial stretching. Further, the thus obtained stretched films may be subjected to heat treatment to obtain films having a dimensional stability.

The method for production of the filaments according to the present invention is not particularly limited. For example, in the case of monofilaments, the raw resin is continuously fed to a single-screw extruder, and continuously melted and extruded into threads from a nozzle provided at a tip end of the extruder. Then, the thus extruded threads are water- or air-cooled and solidified at a temperature of usually 3 to 50° C., preferably 5 to 20° C. to obtain unstretched monofilaments. In this case, when the cooling temperature is too high, the molten resin tends to be crystallized, resulting in poor stretchability and occurrence of whitening thereof. Successively, the resultant unstretched monofilaments are reheated in a tank filled with a heating medium such as warm water, steam and air which is controlled to a temperature near a glass transition temperature of the resin, preferably from 40 to 280° C. Upon the reheating, the monofilaments are stretched usually not less than 1.5 times, preferably 1.8 to 6 times using the difference in rotating velocity between driving rolls disposed before and after the tank. The stretching procedure may be conducted in multiple stages. In this case, the stretching temperature of a downstream stage is preferably set to a higher value than the stretching temperature of an upstream stage. At a final stage, the monofilaments are preferably annealed or relaxed by about several % without stretching in a tank maintained at a temperature of 60 to 280° C. to prevent after-shrinkage thereof.

In the present invention, the temperature used for molding films, sheets or filaments is not particularly limited. When the molding temperature is too high, the resultant molded product tends to undergo deteriorated color tone and increase in end carboxyl group concentration as well as deteriorated hydrolysis resistance. Therefore, the molding temperature is usually not more than 270° C., preferably not more than 265° C., more preferably not more than 260° C. Since the raw PBT of the molded product such as films, sheets and filaments according to the present invention contains no high-viscosity substances which tend to cause fish eyes, even though the molded product is produced at such a low temperature, the formation of the fish eyes can be effectively prevented, thereby achieving both reduction of fish eyes and prevention of thermal degradation upon molding which have been difficult to simultaneously overcome by the convention methods.

Upon producing the molded product of the present invention, ordinary additives may be blended therein, if required. The additives blended are not particularly limited, and there may used, for example, various additives or resins as exemplified as to the above compound product. Further, as the blending method, there may be used the same methods as described as to the above compound product.

In addition, in the present invention, from the standpoints of reduction of wastes discharged, low costs and improving effects of the present invention, commercially non-valuable portions such as typically portions other than final products, e.g., runners and spurs which are produced upon the production of the compound products, and film end portions and sheet end portions which are produced upon the production of the molding products, are preferably recycled by mixing these portions with fresh raw materials. In this case, the runners or spurs, film end portions, sheet end portions, etc., may be directly recycled. Alternatively, in the case where there arise any inconveniences concerning productivity such as adverse influences on biting by screws of feeders for raw materials or molding machines, the films or sheets to be recycled may be subjected to granulation, cutting, pulverization, etc., before recycling. Hereinafter, the above-mentioned parts recycled are referred to as “recycled materials”.

The weight ratio of the recycled materials to the whole raw materials or whole kneading materials including the recycled materials preferably satisfies the following formula (2):
0.01≦C/A≦0.5 (2);
more preferably satisfies the following formula (3):
0.05≦C/A≦0.4 (3); and
still more preferably satisfies the following formula (4):
0.1≦C/A≦0.3 (4),
wherein A represents a total weight of the whole raw materials or the whole molding materials including the recycled materials; and C represents a weight of the recycled materials.

When the weight ratio of the recycled materials is too high, the resultant molded product tends to be deteriorated in color tone, and suffer from increase in content of impurities and end carboxyl group concentration. When the weight ratio of the recycled materials is too low, the effects of reducing the amount of wastes and costs tend to be unattainable.

The molded product of the present invention is not only considerably reduced in fish eyes derived from the high-viscosity substances, but also excellent in color tone, hydrolysis resistance, thermal stability, transparency and moldability, and, therefore, has a high utilization value from industrial viewpoints. Further, the PBT pellet and the compound product of the present invention is excellent in molding property, especially, more excellent in molding property in case of using the recycled materials as a part of the molding materials.

### EXAMPLES

The present invention is described in more detail below by Examples, but the Examples are only illustrative and not intended to limit the scope of the present invention.

Meanwhile, the properties and evaluation items used in the following Examples and Comparative Examples were measured by the following methods.

(1) Esterification Percentage:

The esterification percentage was calculated from the acid value and saponification value according to the following formula (5). The acid value was determined by subjecting a solution prepared by dissolving the oligomer in dimethyl formamide to titration using a 0.1N KOH/methanol solution, whereas the saponification value was determined by hydrolyzing the oligomer with a 0.5N KOH/ethanol solution and then subjecting the hydrolyzed reaction solution to titration using 0.5N hydrochloric acid.
Esterification Percentage=[(Saponification Value)−(Acid Value)]/(Saponification Value)×100 (5)
(2) Intrinsic Viscosity (IV):

The intrinsic viscosity was measured using an Ubbelohde viscometer as follows. That is, using a mixed solvent containing phenol and tetrachloroethane at a weight ratio of 1:1, the drop times (seconds) in a 1.0 g/dL polymer solution and the solvent only were respectively measured at a temperature of 30° C., and the intrinsic viscosity was calculated from the following formula (6):
IV=[(1+4K_{H}χₛₚ)^{0.5}−1]/2K_{H}C (6)
wherein χₛₚ=χ/χ₀−1; χ is a drop time (seconds) in the polymer solution; χ₀ is a drop time (seconds) in the solvent only; C is a concentration (g/dL) of the polymer solution; and K_{H} is a Huggins constant (0.33 was used as the value of K_{H})
(3) Difference (ΔIV) in Intrinsic Viscosity Between Central Portion and Surface Layer Portion of Pellets:

20 g of pellets were allowed to stand in 200 mL of hexafluoroisopropanol, and the hexafluoroisopropanol was periodically replaced with fresh hexafluoroisopropanol. The replacing procedure was repeated 20 times to completely dissolve the pellets in hexafluoroisopropanol. Then, hexafluoroisopropanol was removed from the first recovered solution (fraction 1) and the last (20th) recovered solution (fraction 20), respectively, using an evaporator and a vacuum dryer. After confirming that the amounts of PBT obtained from the respective solutions were less than 2 g, the intrinsic viscosity values of both the PBT products were measured to determine the difference (ΔIV) therebetween.

(4) Titanium Concentration in PBT:

PBT was wet-decomposed with high-purity sulfuric acid and nitric acid used for electronic industries, and measured using high-resolution ICP(inductively coupled plasma)-MS(mass spectrometer) manufactured by Thermo-Quest Corp.

(5) End Carboxyl Group Concentration:

A solution prepared by dissolving 0.5 g of PBT in 25 mL of benzyl alcohol was titrated with a benzyl alcohol solution containing 0.01 mol/L of sodium hydroxide.

(6) End Methoxycarbonyl Group Concentration and End Vinyl Group Concentration:

About 100 mg of PBT was dissolved in 1 mL of a mixed solvent containing heavy chloroform and hexafluoroisopropanol at a volume ratio of 7:3, and the resultant solution was mixed with 36 μL of heavy pyridine and subjected to ¹H-NMR measurement at 50° C. The ¹H-NMR measurement was performed using “α-400” or “AL-400” manufactured by Nippon Denshi Co., Ltd.

(7) Solution Haze:

2.70 g of PBT was dissolved in 20 mL of a mixed solvent containing phenol and tetrachloroethane at a weight ratio of 3:2 at 110° C. for 30 min, and then cooled in a constant-temperature water vessel at 30° C. for 15 min. The haze of the solution was measured using a turbidity meter “NDH-300A” with a cell length of 10 mm manufacture by Nippon Denshoku Co., Ltd. The lower the haze value, the more excellent the transparency of the solution.

(8) Color Tone of Pellets:

Using a color difference meter “Z-300A Model” manufactured by Nippon Denshoku Co., Ltd., the b value of the pellets in a L,a,b color specification system was measured, and the color tone of the pellets was evaluated by the thus measured b value. The lower the b value, the less the yellowness and the more excellent the color tone.

(9) Amount of Formaldehyde Generated:

1 g of PBT and 5 mL of an aqueous hydrochloric acid solution whose pH value was controlled to 2.29 were placed in a 10 mL headspace bottle, and extracted under stirring at 120° C. for one hour. The resultant extracted solution was cooled and then filtered through a chromatographic disk. Further, about 3 g of the obtained solution was accurately weighed, and 0.2 mL of a 6N hydrochloric acid solution containing 0.25% of 2,4-dinitrophenyl hydrazine and 1 mL of hexane were added thereto to react with each other at 50° C. for 20 min. The resultant hexane phase was separated from the reaction solution, and analyzed using Gas Chromatography “GC2010” (column: HP-5MS; manufactured by Shimadzu Seisakusho Co., Ltd.).

(10) Number of Fisheyes:

First, PBT was dried in a nitrogen atmosphere at 120° C. for 8 hours, and then molded using a film-molding machine “Model ME-20/26V2” manufactured by Optical Control Systems Inc., thereby obtaining a 50 μm-thick film. At this time, the temperatures of the cylinder and die of the molding machine were controlled to temperatures in Examples and Comparative Examples, respectively. Then, the number of fish eyes in the thus obtained film was measured as follows. That is, using a film quality testing system “Type FS-5” manufactured by Optical Control Systems Inc., the number of fisheyes having a size of more than 200 μm per 1 m² of the film was counted.

(11) ΔAV upon Molding:

The end carboxyl group concentrations in the raw pellets and the film obtained in the above item (10) were respectively measured, and the difference (ΔAV) between the end carboxyl group concentrations before and after molding (raw pellets and film) was determined as ΔAV upon molding.

(12) Stability of Motor Torque in Extruder:

The value of a motor torque (Nm) upon molding the film in the above item (10) was observed to evaluate a stability thereof. The results were classified into Rank “Good” in which fluctuation of the motor torque during the film-molding process was within 10%, and Rank “Bad” in which fluctuation of the motor torque during the film-molding process was more than 10%.

### Example 1

PBT was produced through the esterification process shown in FIG. 1 and the polycondensation process shown in FIG. 2 by the following procedure. First, terephthalic acid was mixed with 1,4-butanediol at 60° C. at a molar ratio of 1.00:1.80 in a slurry preparation tank. The thus obtained slurry was continuously supplied at a feed rate of 40.0 kg/h from the slurry preparation tank through a raw material feed line (1) to an esterification reaction vessel (A) equipped with a screw-type stirrer which was previously filled with PBT oligomer having an esterification rate of 99%. Simultaneously, a bottom component of a rectifying column (C) at 185° C. was supplied at a feed rate of 18.4 kg/h through a recirculation line (2) to the reaction vessel (A), and further a 1,4-butanediol solution containing 6.0% by weight of tetrabutyl titanate as a catalyst at 65° C. was supplied through a catalyst feed line (3) to the reaction vessel (A) at a feed rate of 95 g/h (30 ppm by weight based on theoretical yield of polymer). The water content in the catalyst solution was 0.20% by weight.

While maintaining an inside temperature and pressure of the reaction vessel (A) at 230° C. and 78 kPa, respectively, water by-produced, THF and an excess amount of 1,4-butanediol were distilled off through a distillate line (5) and delivered to the rectifying column (C) where these distillates were separated into a high-boiling component and a low-boiling component. After the system was stabilized, a part of the high-boiling component as a bottom component containing 1,4-butanediol in an amount of not less than 98% by weight, was withdrawn from the bottom of the rectifying column (C) and partially discharged outside through a discharge line (8) so as to keep a liquid level in the rectifying column (C) constant. On the other hand, the low-boiling component was removed in a gaseous state from a top of the rectifying column (C), and condensed in a condenser (G). The thus recovered low-boiling component was discharged outside through a discharge line (13) so as to keep a liquid level in a tank (F) constant.

A predetermined amount of the oligomer produced in the reaction vessel (A) was withdrawn through a discharge line (4) using a pump (B) to control the liquid level in the reaction vessel (A) such that an average residence time of the liquid therein was 3.5 hr. The oligomer withdrawn through the discharge line (4) was continuously supplied to a first polycondensation reaction vessel (a). After the system was stabilized, the oligomer was sampled at an outlet of the reaction vessel (A). As a result, it was confirmed that the esterification rate of the oligomer was 97.5%.

The liquid level in the first polycondensation reaction vessel (a) was controlled such that the inside temperature, pressure and residence time were 245° C., 2.1 kPa and 90 min, respectively. While withdrawing water, THF and 1,4-butanediol through a vent line (L2) connected to a pressure-reducing device (not shown), the initial polycondensation reaction was conducted. The thus withdrawn reaction solution was continuously supplied to a second polycondensation reaction vessel (d).

The liquid level in the second polycondensation reaction vessel (d) was controlled such that the inside temperature, pressure and residence time were 241° C., 150 Pa and 90 min, respectively. While withdrawing water, THF and 1,4-butanediol through a vent line (L4) connected to a pressure-reducing device (not shown), the polycondensation reaction was further conducted. The thus obtained polymer was withdrawn and delivered through a discharging gear pump (e) and a discharge line (L3), and continuously supplied to a third polycondensation reaction vessel (k). While controlling the liquid level in the third polycondensation reaction vessel (k) such that the inside temperature, pressure and residence time were 238° C., 140 Pa and 90 min, respectively, the polycondensation reaction was further conducted. The thus obtained polymer was supplied to a die head (g) from which the polymer was then continuously extruded into strands. The strands were cut into pellets by a rotary cutter (h). The thus obtained PBT pellets having an average intrinsic viscosity (average IV) of 1.00 dL/g, a titanium content of 30 ppm by weight and a ΔIV of less than 0.01 dL/g, were molded into a film at 250° C. As a result of evaluating the resultant film, it was confirmed that the film exhibited a less number of fish eyes and a good appearance. The results are shown in Table 1.

### Example 2

The same procedure as defined in Example 1 was conducted except that the inside temperature in the second polycondensation reaction vessel (d) was changed to 243° C., and the pressure and residence time in the third polycondensation reaction vessel (k) were changed to 130 Pa and 100 min, respectively. The thus obtained PBT pellets having an average IV of 1.25 dL/g, a titanium content of 30 ppm by weight and a ΔIV of less than 0.01 dL/g were molded into a film at 250° C. As a result of evaluating the resultant film, it was confirmed that the film exhibited a less number of fish eyes and a good appearance. The results are shown in Table 1.

### Example 3

The same procedure as defined in Example 1 was conducted except that the inside temperature and residence time in the second polycondensation reaction vessel (d) were changed to 244° C. and 80 min, respectively, and the pressure and residence time in the third polycondensation reaction vessel (k) were changed to 130 Pa and 120 min, respectively. The thus obtained PBT pellets having an average IV of 1.35 dL/g, a titanium content of 30 ppm by weight and a ΔIV of less than 0.01 dL/g were molded into a film at 250° C. As a result of evaluating the resultant film, it was confirmed that the film exhibited a less number of fish eyes and a good appearance nevertheless the high average IV. The results are shown in Table 1.

### Example 4

The same procedure as defined in Example 1 was conducted except that the titanium amount as the tetrabutyl titanate amount used was changed to 75 ppm by weight based on theoretical yield of the polymer, the inside temperature and residence time in the second polycondensation reaction vessel (d) were changed to 242° C. and 80 min, respectively, and the pressure in the third polycondensation reaction vessel (k) were changed to 130 Pa. The thus obtained PBT pellets having an average IV of 1.25 dL/g, a titanium content of 75 ppm by weight and a ΔIV of less than 0.01 dL/g were molded into a film at 250° C. As a result of evaluating the resultant film, it was confirmed that the film exhibited a less number of fish eyes and a good appearance. The results are shown in Table 1.

### Example 5

The PBT pellets obtained in Example 2 were molded into a film at a temperature of 265° C. As a result of evaluating the resultant film, it was confirmed that the film exhibited a less number of fish eyes and a good appearance. The results are shown in Table 1.

### Comparative Example 1

A 200 L stainless steel reaction vessel equipped with turbine-type agitation blades was charged with 272.9 mol of dimethyl terephthalate (DMT), 327.5 mol of 1,4-butanediol and 0.038 mol of tetrabutyl titanate (titanium amount: 30 ppm by weight based on theoretical yield of the polymer), and fully purged with nitrogen. Successively, the temperature of the system was raised. After the elapse of 60 min, the contents of the reaction vessel were subjected to transesterification reaction at 210° C. for 2 hours under an atmospheric pressure of nitrogen while distilling off methanol produced, 1,4-butanediol and THF out of the system (the reaction initiation time was regarded as the time at which the predetermined temperature and pressure were reached).

The obtained oligomer was transferred to a 200 L stainless steel reaction vessel equipped with a vent tube and double helical-type agitation blades. After the temperature and pressure in the reaction vessel reached 245° C. and 100 Pa, respectively, for 60 min, the polycondensation reaction was conducted for 1.5 hours while keeping the temperature and pressure. After completion of the reaction, the obtained polymer was extruded into strands, and then cut into pellets. The thus obtained PBT pellets were charged into a 100 L double cone-type jacketed solid-phase polymerization reactor, and subjected to pressure reduction/purge with nitrogen three times. Next, the temperature in the reactor was raised to 200° C. while controlling a pressure in the reactor to 130 Pa, and the PBT in the reactor was periodically sampled. The polycondensation reaction was conducted while monitoring the IV of the PBT, and finally stopped at the time at which the IV of the PBT reached 1.25. It was confirmed that the amount of formaldehyde generated from the PBT was 0.8 ppm by weight. The thus obtained PBT pellets having an average IV of 1.25 dL/g, a titanium content of 30 ppm by weight and a ΔIV of 0.19 dL/g were molded into a film at 250° C. As a result of evaluating the resultant film, it was confirmed that the film exhibited a large number of fish eyes and a poor appearance. Also, there was generated a large fluctuation of the torque in the extruder. The results are shown in Table 1.

### Comparative Example 2

The PBT pellets obtained in Comparative Example 1 were molded into a film at 280° C. As a result of evaluating the resultant film, it was confirmed that the film exhibited a slightly smaller number of fish eyes as compared to that of the film obtained in Comparative Example 1, and still showed a poor appearance. In addition, it was confirmed that the PBT was considerably increased in end carboxyl group concentration after molding. Also, there was generated a large fluctuation of the torque in the extruder. The results are shown in Table 1.

### Comparative Example 3

The same procedure as defined in Comparative Example 1 was conducted except that the solid-phase polymerization time was prolonged, thereby obtaining PBT having an average IV of 1.35 dL/g, a titanium content of 30 ppm by weight and a ΔIV of 0.24 dL/g. It was confirmed that the amount of formaldehyde generated from the PBT was 0.7 ppm by weight. The obtained PBT pellets were molded into a film at 250° C. As a result of evaluating the resultant film, it was confirmed that the film exhibited a larger number of fish eyes than that of the film obtained in Comparative Example 1 and a poor appearance. Also, there was generated a large fluctuation of the torque in the extruder. The results are shown in Table 1.

### Comparative Example 4

The same procedure as defined in Example 1 was conducted except that the titanium amount as the tetrabutyl titanate amount used was changed to 100 ppm by weight based on theoretical yield of polymer, and the inside temperature and residence time in the second polycondensation reaction vessel (d) were changed to 240° C. and 80 min, respectively. The thus obtained PBT pellets having an average IV of 1.25 dL/g, a titanium content of 100 ppm by weight and a ΔIV of less than 0.01 dL/g were molded into a film at 250° C. As a result of evaluating the resultant film, it was confirmed that the film exhibited a large number of fish eyes and a poor appearance. The results are shown in Table 1.

### Example 6

70 parts by weight of the PBT pellets used in Example 2 and 30 parts by weight of the material obtained by pulverizing and drying the film (R0) obtained in Example 2 were blended with each other, and then molded into a film by the same method as defined in Example 2. Next, 30 parts by weight of a film (R1) containing one-time recycled material and 70 parts by weight of the PBT pellets used in Example 2 were blended with each other, and then molded into a film by the same method as defined in Example 2 (R2). The above procedure was repeated to obtain a film (R4) containing three-time recycled material. As a result, it was confirmed that although the procedure of blending the recycled material was repeated, the obtained PBT film still exhibited a good quality. The results are shown in Table 2.

### Comparative Example 5

Using the PBT pellets obtained in Comparative Example 1, a film (R4) containing three-time recycled material was obtained by the same method as defined in Example 6. As a result, it was confirmed that the end carboxyl group concentration in the PBT was considerably increased, and the obtained PBT film exhibited a large number of fish eyes and was deteriorated in color tone and strength. The results are shown in Table 2.

TABLE 1

| | | Examples | | | | |
|---|---|---|---|---|---|---|
| | | 1 | 2 | 3 | 4 | 5 |
| Raw PBT | | | | | | |
| Average IV | dL/g | 1.00 | 1.25 | 1.35 | 1.25 | 1.25 |
| ΔIV | dL/g | <0.01 | <0.01 | <0.01 | <0.01 | <0.01 |
| [Ti] | ppm by | 30 | 30 | 30 | 75 | 30 |
| | weight | | | | | |
| End carboxyl | μeq/g | 17 | 22 | 25 | 27 | 22 |
| group | | | | | | |
| concentration | | | | | | |
| End methoxy- | μeq/g | <0.1 | <0.1 | <0.1 | <0.1 | <0.1 |
| carbonyl group | | | | | | |
| concentration | | | | | | |
| End vinyl group | μeq/g | 6 | 8 | 9 | 9 | 8 |
| concentration | | | | | | |
| Solution haze | % | ≦0.1 | ≦0.1 | ≦0.1 | 21 | ≦0.1 |
| b value of | — | −1.6 | −1.3 | −0.8 | −0.5 | −1.3 |
| pellets | | | | | | |
| Amount of | ppm by | <0.1 | <0.1 | <0.1 | <0.1 | <0.1 |
| formaldehyde | weight | | | | | |
| generated | | | | | | |
| Film properties | | | | | | |
| End carboxyl | μeq/g | 23 | 26 | 29 | 33 | 29 |
| group | | | | | | |
| concentration | | | | | | |
| ΔAV upon | μeq/g | 6 | 4 | 4 | 6 | 7 |
| molding | | | | | | |
| Number of fish | per m² | 15 | 10 | 12 | 56 | 9 |
| eyes | | | | | | |
| Fluctuation of | — | Good | Good | Good | Good | Good |
| torque in extruder | | | | | | |

| | | Comparative Examples | | | |
|---|---|---|---|---|---|
| | | 1 | 2 | 3 | 4 |
| Raw PBT | | | | | |
| Average IV | dL/g | 1.25 | 1.25 | 1.35 | 1.25 |
| ΔIV | dL/g | 0.19 | 0.19 | 0.24 | <0.01 |
| [Ti] | ppm by | 30 | 30 | 30 | 100 |
| | weight | | | | |
| End carboxyl | μeq/g | 17 | 17 | 14 | 24 |
| group | | | | | |
| concentration | | | | | |
| End methoxy- | μeq/g | 8.6 | 8.6 | 8.2 | <0.1 |
| carbonyl group | | | | | |
| concentration | | | | | |
| End vinyl group | μeq/g | 6 | 6 | 7 | 7 |
| concentration | | | | | |
| Solution haze | % | ≦0.1 | ≦0.1 | ≦0.1 | 40 |
| b value of | — | −1.0 | −1.0 | −0.8 | 1.0 |
| pellets | | | | | |
| Amount of | ppm by | 0.8 | 0.8 | 0.7 | <0.1 |
| formaldehyde | weight | | | | |
| generated | | | | | |
| Film properties | | | | | |
| End carboxyl | μeq/g | 24 | 28 | 23 | 34 |
| group | | | | | |
| concentration | | | | | |
| ΔAV upon | μeq/g | 7 | 11 | 9 | 10 |
| molding | | | | | |
| Number of fish | per m² | 80 | 72 | 155 | 85 |
| eyes | | | | | |
| Fluctuation of | — | Bad | Bad | Bad | Good |
| torque in extruder | | | | | |

TABLE 2

| | | | Comparative |
|---|---|---|---|
| Film properties | | Example 6 | Example 5 |
| End carboxyl group | μeq/g | 28 | 29 |
| concentration | | | |
| ΔAV upon molding | μeq/g | 6 | 12 |
| Number of fish eyes | per m² | 15 | 120 |
| Fluctuation of | — | Good | Bad |
| torque in extruder | | | |

1. A polybutylene terephthalate pellet comprising polybutylene terephthalate containing titanium in an amount of not more than 90 ppm by weight, as calculated as titanium atom, and having an end methoxycarbonyl group concentration of not more than 0.5 μeq/g, wherein said pellet has an average intrinsic viscosity of 0.90 to 2.00 dL/g and a difference in intrinsic viscosity between a central portion and a surface layer portion of the pellet is not more than 0.10 dL/g.

2. A polybutylene terephthalate pellet according to claim 1, wherein said pellet has an average intrinsic viscosity of 1.10 to 1.40 dL/g.

3. A polybutylene terephthalate pellet according to claim 1, wherein said polybutylene terephthalate has a titanium content of not more than 50 ppm by weight.

4. A polybutylene terephthalate pellet according to claim 1, wherein said polybutylene terephthalate has an end carboxyl concentration of 0.1 to 50 μeq/g.

5. A polybutylene terephthalate pellet according to claim 1, wherein said polybutylene terephthalate has an end vinyl concentration of 0.1 to 15 μeq/g.

6. A polybutylene terephthalate pellet according to claim 1, wherein said polybutylene terephthalate has an solution haze of not more than 5%, when measured as a turbidity value of a solution prepared by dissolving 2.7 g of polybutylene terephthalate in 20 mL of a mixed solution containing phenol and tetrachloroethane at a weight ratio of 3:2.

7. A polybutylene terephthalate pellet according to claim 1, wherein the difference in intrinsic viscosity between the central portion and surface layer portion of the pellet is not more than 0.05 dL/g.

8. A compound product produced using the polybutylene terephthalate pellet as defined in claim 1 as at least a part of a raw material thereof.

9. A process for producing a compound product, comprising kneading a raw material using the polybutylene terephthalate pellet as defined in claim 1 as at least a part of the raw material, by an extruder.

10. A process according to claim 9, wherein a resin temperature upon kneading by the extruder is not more than 270° C.

11. A molded product produced using the compound product as defined in claim 8 as at least a part of a raw molding material thereof.

12. A process for producing a molded product, comprising molding a raw material using the compound product as defined in claim 8 as at least a part of the raw molding material, by an injection molding machine.

13. A process according to claim 12, wherein a melting temperature of the compound product upon molding is not more than 270° C.

14. A process according to claim 12, wherein a recycled material is used as at least a part of the raw molding material.

15. A molded product produced using the polybutylene terephthalate pellet as defined in claim 1 as at least a part of a raw material thereof.

16. A molded product according to claim 15, wherein the molded product is a film, a sheet or a filament.

17. A process for producing a molded product, comprising molding a raw material using the polybutylene terephthalate pellet as defined in claim 1 as at least a part of the raw material, by an extruder.

18. A process according to claim 17, wherein a molten resin temperature upon molding is not more than 270° C.

19. A process according to claim 17, wherein a recycled material is used as at least a part of the raw material.
